(19) United States
(12) Patent Application Publication
(10) Pub. No.: US 2020/0011779 A1
(43) Pub. Date: Jan. 9, 2020

(54) HIGHLY INTEGRATED OPTICAL PARTICLE COUNTER (OPC)

(71) Applicant: CLAD INNOVATIONS LTD., Pitt Meadows (CA)

(72) Inventors: Vladislav Igorevich Lavrovsky, Vancouver (CA); Taylor Cooper, Coquitlam (CA); Aaron Joseph MacDonald, Garibaldi Highlands (CA)

(21) Appl. No.: 16/338,437

(22) PCT Filed: Sep. 29, 2017
(86) PCT No.: PCT/CA2017/000216

§ 371 Date: Mar. 29, 2019

Related U.S. Application Data
(60) Provisional application No. 62/401,697, filed on Sep. 29, 2016.

(51) Int. Cl. G01N 15/02; G01N 15/06; G01N 15/14; G01N 21/53

(52) U.S. Cl. CPC G01N 15/0205; G01N 15/06; G01N 2015/0046; G01N 21/53; G01N 15/1459

(57) ABSTRACT

An apparatus and system for detecting and measuring particles entrained in an air stream. The apparatus and system include an enclosure configured to define an aerosol sampling path and an optical path. The aerosol sampling path allows an air stream having entrained particles to pass therethrough. The aerosol sampling path intersects with the optical path. The intersection defines a sensing region. The sensing region may use a band pass filter to improve signal to noise ratio. At least one flow rate sensor may be located near the sensing region. A light source provides a light beam along the optical path. The light beam intersects with the air stream in the sensing region, wherein the light beam may be scattered by entrained particles contained in the aerosol sampling path.

### 1. FIELD OF THE INVENTION

This invention relates generally to light scattering of particulate matter entrained in a fluid using optical techniques.

### 2. BACKGROUND OF THE INVENTION

There may be a growing market demand for inexpensive air quality monitors for both research and personal health. Airborne particulate matter may be among the deadliest forms of air pollution. The risk of lung cancer may be greatly increased by the concentration of particulate matter below PM10. Asthma, cardiovascular disease, respiratory diseases and birth defects have also been associated with increases in airborne particulate matter concentration. In addition, these conditions are a detriment to the economy, resulting in thousands of workers on sick leave per day and billions of dollars of strain on health care systems around the world. Environmental researchers often do not have the budget to purchase multiple devices to develop data maps in order to monitor these adverse environmental conditions.

Airborne particulate matter can be measured gravimetrically to determine the mass concentration of matter in aerosol. However, this method may be time consuming and often requires manual procedures. More recently, particulate matter has been measured with a light scattering aerosol spectrometer (“LSAS”). These sensors count and size particles individually, respond quickly to changing environmental conditions, and can continuously monitor conditions for months without user intervention.

Typically a LSAS works by drawing a sample of air through a beam of light. The beam of light may be scattered due to the particles entrained in the sample of air. Optical collection systems direct the scattered light to a photodiode, which in turn converts the collected light into current that may be then amplified into an analog voltage signal. The voltage signal may be typically a pulse, where the pulse width and amplitude are proportional to the light intensity and particle diameter. The particle size, incident light, and other physical characteristics may be determined from this pulse. The concentration of particles entrained in the sample of air may also be determined by analyzing the pulses over time.

An inlet may be typically used to draw a sample of air through the sensor. It may take the form of a nozzle or jet with either a round or rectangular profile. The round inlet provides a larger cross-section and requires a lower vacuum than the rectangular profile, resulting in lower power consumption. Although the round inlet may be simpler to implement, the circular air flow has reduced uniformity and higher variations in light intensity across the intersection of the air flow and light beam. The rectangular profile provides better particle resolution because the flattened and wide air flow moves at a fairly uniform velocity and intersects the light beam at the most intense and uniform region. However, the rectangular profile may be more complex and expensive to manufacture. One difficulty that arises may be that the velocity and volume of air flow will vary over time as a function of device location and age thus any calibration done to allow conversion to mass concentration will fail over time.

As a particle passes through the laser, light may be reflected and focused by the collection optics onto a photodiode. One difficulty in collection optics may be the dependency of scattered light direction on particle size. Ideally, the sensor assembly captures all light and focuses it on to the photodiode while removing any unwanted light. Smaller particles typically scatter in the forward direction, whereas larger particles scatter at backward and right angles. If particles are significantly smaller than the cross-section of the light beam, they may not generate a high enough pulse to be distinguishable from signal noise. Border zone error occurs when particles straddle the optical border of the sensing zone, resulting in only a fraction of the light to be scattered. Coincidence error can occur with high particle number concentrations, where two or more particles are simultaneously present in the sensing zone.

Another difficulty lies in transport losses in the sampling tubing. The sampling system is part of a measurement chain and follows aerosol extraction, transport, and processing; the quality of the overall measurement may be determined by the weakest element of this chain. The aerosol particles in the transport tubing can be affected by diffusion, sedimentation, inertia, condensation effects, and coagulation. Coagulation may be a function of the collision and adhesion of particles. This results in a larger particle diameter and a smaller particle number concentration with constant mass concentration.

Current LSAS sensors are often complex and difficult to manufacture, as airborne particulate monitoring can be expensive, laborious, or inconvenient. In addition, airborne particulate matter has a strong link to lung cancer and cardiovascular disease. This results in a need for a low cost, effective method of monitoring and tracking environmental conditions.

### 3. SUMMARY OF THE INVENTION

The present invention provides an improved method for detecting and measuring air contaminants, such as particles, entrained in a fluid by a small, low power device. This embodiment of the invention contains the following components, known to those skilled in the art of laser scattering aerosol spectrometry: an enclosure, a fan, a flow sensor, a laser and a printed circuit board (PCB). The enclosure consists of components for: containing the sensor, bandpass filter 20, baffling for stray light, baffling for airflow control and user interaction. The PCB has the following components: a flow sensor, photodiode, an amplifier circuit, an ADC, an MCU or DSP and control electronics. Other embodiments of the device may contain a plurality of any of these components.

In this embodiment of the invention, the light scattering device draws a continuous sample of fluid through a light beam by means of a vacuum created with an axial or centrifugal fan. The light beam geometry may be reflected such that the beam length and geometry may be maintained while reducing the required area. The photodiode has a large sensing area, thus reducing the need for optical collection systems to collect the light scattered by entrained particles within the sensing volume. In some embodiments of the invention, an optical collection system may be included to focus the scattered light on to the photodiode.

The detailed description of the invention covers many improvements to the traditional LSAS, including an approach for minimizing flow channel contamination and its limitations; methods for implementation of stray light attenuation; techniques for increasing the sensitivity of the LSAS; methods for reducing power consumption of the device; and techniques for diagnostics that overcome drift and error.

### 4. BRIEF DESCRIPTION OF THE DRAWINGS

FIG. 1C may be a perspective drawing of a particle sensor constructed according to the principles of the present invention.

FIG. 1B may be an exploded view of the device in FIG. 1C

FIG. 1A may be a perspective drawing of the device with the top cover removed.

FIG. 2 may be a top view of one embodiment of the arrangement of sensor components within the device. The sensing region may be the area defined by the feature 17.

FIG. 3 may be a perspective drawing of one embodiment of a particle sensor constructed according to the principles of the present invention

FIG. 4 may be an exploded view of the apparatus of FIG. 3

FIG. 5 may be a diagrammatic top view of one embodiment of the arrangement of sensor components on the printed circuit board. The intersection between section views A-A and B-B represent the sensing region above the photodiode

FIG. 6 may be a side section view of FIG. 3 of the aerosol sampling path above the photodiode.

FIG. 7 may be a front section view of FIG. 3 of the optical path of the laser above the photodiode.

FIG. 8 may be an example of a signal pulse output from the photodiode.

### 5 DETAILED DESCRIPTION OF THE INVENTION

### 5.1 Enclosure

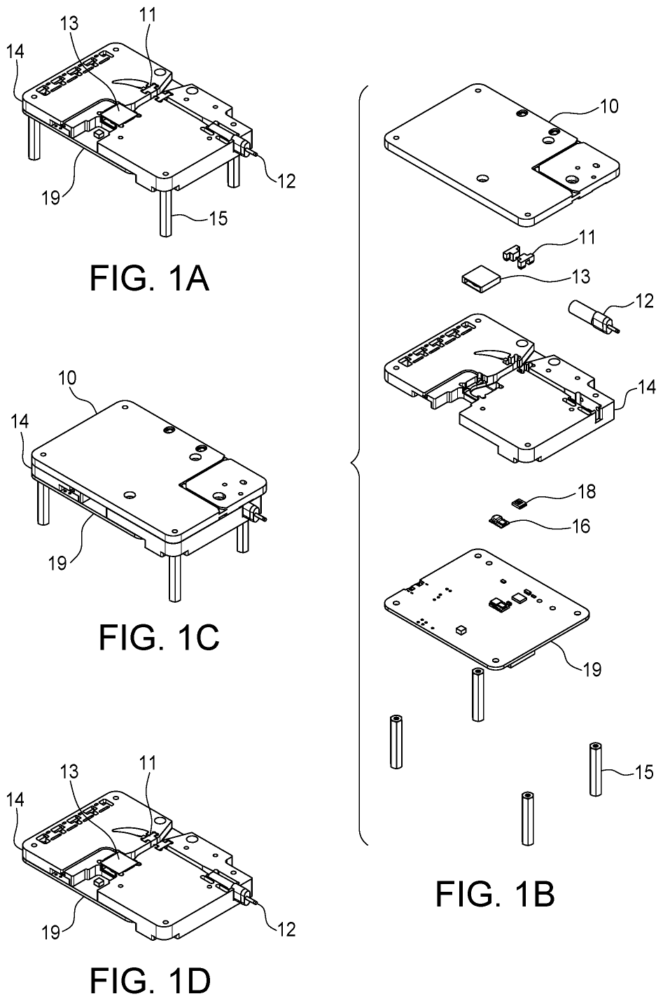

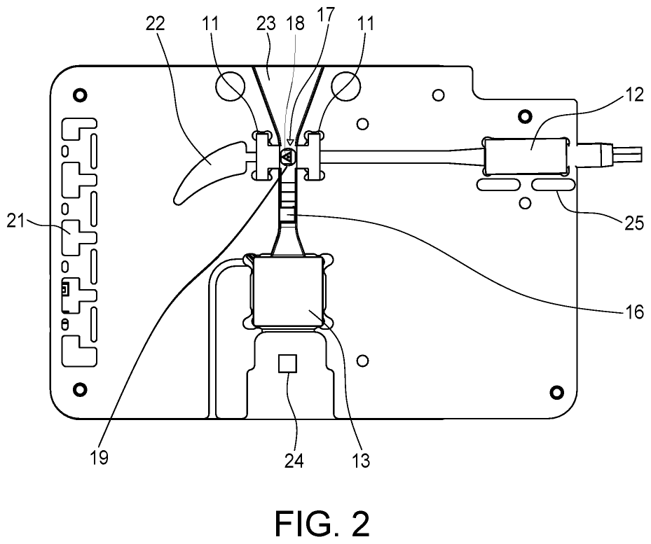

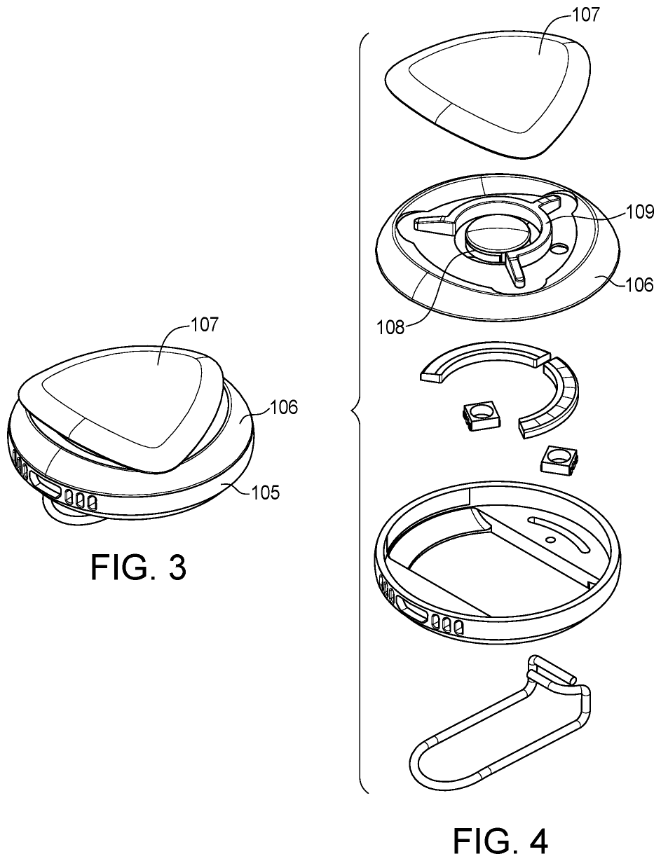

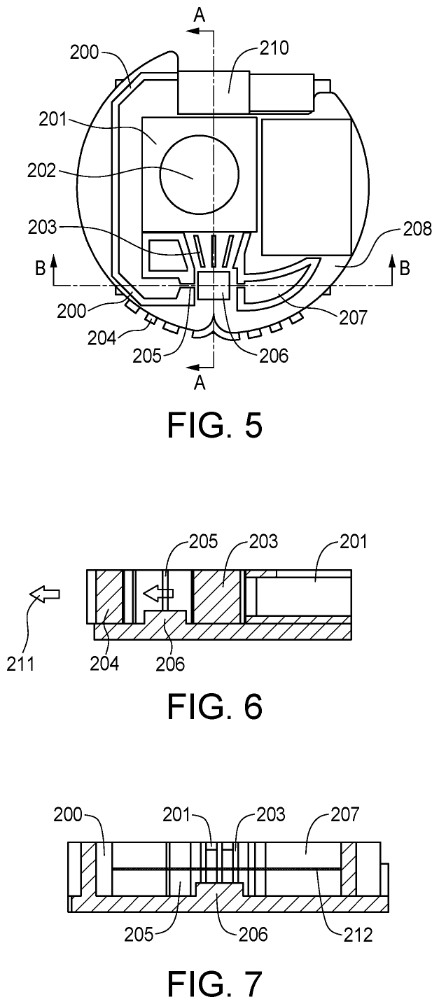

One embodiment of the enclosure may be illustrated in FIG. 1. The enclosure consists of three or more components which may be ultrasonically welded, screwed, clipped, or otherwise held together. These components may be constructed using plastic, but other materials are also suitable. The sensor in FIG. 5 may be partially or fully contained by this enclosure.

The three major components of the enclosure are the PCB 19, OPC frame 14 and the top cover 10. Other embodiments may consider just the PCB 19 and OPC frame 14. The top cover 10 may have one or more mounting/access feature for additional sensors. Other embodiments may have significantly different dimensions and geometry than shown in FIG. 1. Additional components may be used inside the enclosure other than the major components to aid in the function of the device.

Any part of the enclosure may have an engineered surface finish and/or selective metal deposition/plating for aesthetic and/or optical reasons. A metal finish may be used to create mirrors for the optical system. The enclosure may be curved to create mirrors with different optical behaviors. Any part of the enclosure may contain features for directing the air flow for the sensor. Gaskets, flexible plastic, epoxy, tape or other materials may be used to improve the function of these features. Features may be added to any part of the enclosure to reduce or increase intake or outlet air flow velocities. Any part of the enclosure may contain overlapping baffles 11 to prevent stray light from reaching the sensor. Any part of the enclosure may be coated or covered with a light absorbing paint, finish, tape, and/or other material.

In one embodiment the OPC frame 14 may be composed of plastic, the material of the plastic may be dimensionally stable over temperature to prevent misalignment of the optical components. The OPC frame 14 may be composed of a single material or a composite of multiple materials, which may be engineering thermoplastics such as PEEK, PPS, PET or other dimensionally stable material.

In one embodiment the OPC frame 14 may be composed of a thermoplastic that may be tough and resistant to impacts such as nylon, UHMW, or other plastics. This embodiment may be for applications where physical impacts and rough handling are common.

The OPC frame 14 may be sealed or painted to prevent or slow the rate of water absorption with the atmosphere. In this way the stability of the OPC frame 14 may be maintained over long periods of time.

### 5.2 Sensing Region

The sensing region 17 may be defined as the intersection between the aerosol transit path and the optical path above the photodiode 18. In an embodiment, the sensing region may contain a photodiode 18, aperture 19, and optionally a band pass filter (not shown). In an embodiment, the band pass filter sits on top of the photodiode 18 and entirely within the aperture 19. In this embodiment, the depth of the aperture may be equal to the height of the band pass filter, such that when assembled, the top surfaces of the material surrounding the aperture and band pass filter are coplanar and flush. Alternatively, the depth of the aperture may be not equal to the height of the band pass filter. In an embodiment, the band pass filter may be integral with the photodiode, where the body or outer surface of the photodiode comprises a similar material as the band pass filter. This configuration attenuates wavelengths of light that are not of the desired excitation wavelength. Different band pass filter materials may be used to select different spectra, or wavelengths of light ranges. In an embodiment, the sensing region 17 may be placed upstream from the fan 13 in a laminar flow zone. The fan 13 exhausts air from the device, which makes the air turbulent. In this embodiment the air flow sensor 16 may be placed after the photodiode 18, but it may be anywhere along the air flow path 23. In order to minimize stray light from both the laser 12 and any light from outside the device, the sensing region 17 may be enclosed in opaque plastics that attenuate reflected light and prevent illumination of the sides or edges of the photodiode 18. There may be an aperture 19 that allows light into the photodiode. Only the center of the active area of the photodiode 18 may be exposed by the aperture 19, directly below the sensing region.

In another embodiment, the photodiode 18 may be of a construction that directly blocks stray light in all axis other than the axis of the active area. The package of the photodiode may be constructed of a dark plastic, ceramic or metal and does not allow infiltration of stray light. This reduces the required tolerances as the centering of the light aperture becomes less critical.

In one embodiment, to further reduce stray light from sources external to the device, the photodiode may have an optical bandpass filter 20 integrated. This may be a separate component placed on top of, inside or underneath the aperture 19. In another embodiment, the optical bandpass filter 20 may be integrated directly onto the photodiode glass. The bandpass filter 20 chemistry may be selected to pass a narrow band of wavelengths centered around the center wavelength of the laser. In this manner, the majority of the light spectrum from household lighting, street lights, solar irradiance and other sources may be attenuated. This greatly reduces the need for mechanical baffling and results in lower impedance in the air path.

### 5.3 Fan

In an embodiment, the device has a fan 13. A small blower style fan 13 may be used to draw air into the device. It may be configured to either pull or push air across the sensing region. In this embodiment, the fan 13 may be placed such that the exhaust may be oriented away from the sensing region 17. The exhaust area 24 may be populated by a plurality of sensors that require gas exchange but do not require laminar or otherwise controlled air currents. Sensors that may be populated in the exhaust region 24 include humidity, temperature, pressure, C02, 02, VOC or NOX sensors, among other sensors used in quantification of gases.

The fan 13 may be exposed to environmental conditions of a broad variety and must survive exposure to temperature cycling, high humidity and even direct inundation with water by rain or other events. In an embodiment, the air sampling path 23 may be constructed such that any water ingress can be resolved by tipping the device at an angle. The fan 13 may be installed in a recessed area of the OPC frame 14 such that the inside surface of the fan body 13 may be flush with the surface of the air path 23. This ensures that any water that may be present can escape the device. The device may have channels or grooves in the air path 23 to guide the flow of water to the outside of the enclosure.

The device has cable management features integrated in the OPC frame 14 to allow routing of wire harnesses. In this embodiment, the wires from the fan 13 are routed to the edge of the device where the wires can be terminated by soldering to the PCB 19 directly proximal to the OPC frame 14. In another embodiment, the fan 13 has contacts directly on the surface of the fan body, these contacts mate with contacts that are populated on the surface of the PCB 19 facing the OPC frame 14. The fan 13 may be held down on top of contacts by the cover. These contacts may be spring pins, bend sheet metal, or any other interconnect device capable of displacement or elastic deformation. In that embodiment, the fan 13 may be easily replaceable because no soldering may be required. Thus, this embodiment allows the user to service the fan 13 without specialized tools or knowledge.

In one embodiment, there may be no fan in the device. The device relies on passive movement of air generated by the movement of the user, movement of a vehicle or natural air currents such as wind or drafts. One embodiment may have a very large intake 23 cross section to collect a larger volume of air, in this way it can accept a wider dynamic range of air current velocities.

### 5.4 Flow Measurement

Measuring air flow rate in the aerosol sensing path may be necessary to increase the accuracy of particle counting and subsequent conversion to mass concentration. Continuous real time corrections to the flow rate and thus the mass displacement are necessary to correct for short and long term errors due to contamination, bearing failure, loading of the fan blades, clogging of the air path, obstruction of the inlet and exhaust, changes to device orientation, acceleration of the device, user movement and ambient air currents such as wing and drafts, among others sources of error. The microcontroller unit (MCU), digital signal processor (DSP), or control electronics in the device use air flow rate measurements, which may be used to determine the correlation factor between particle counts and mass concentration, and/or for closed loop control of the fan to increase sensor accuracy and/or reduce the contamination rate of the sensor.

Air flow rate may be sensed through a plurality of the following methods or other methods. In one embodiment, a device using a heating coil and thermistor may be placed such that it has sufficient thermal contact with the fluid in the aerosol sampling path. The thermistor may be used to make a measurement of the steady state ambient temperature when the heating coil may be driven at a constant power. The rise and decay time of the temperature correlates with the aerosol flow rate near the sensor.

This device may also be used to conduct temperature compensation for the sensor as some components in the device have temperature-dependent responses. This device may be found as an existing electronic component and mounted to the PCB 208. A plurality of these devices may be placed along the aerosol sampling path 211, before and/or after the photodiode 206, to measure flow rate in critical regions.

In one embodiment, a pressure sensing device may be used to determine the air flow by following Poiseuille's Law, stating that the volumetric flow may be found given the pressure difference between two points along the air stream and the viscous resistance. A plurality of these components may be placed before and/or after the photodiode 206 and along the aerosol sampling path 211 to measure flow in critical regions. This device may be found as an existing electronic component and mounted to the PCB.

In one embodiment, air flow may be inferred from the rotational speed of the fan 201. Rotational speed of the fan 201 may be measured by means of a pulse count or analog voltage from an optical sensor, Hall effect sensor, or other odometer connected to or integrated with the fan 201; measurement of the total current, voltage or power consumption of the fan; and/or pulse counting of the peak current and/or voltage drawn by the fan 201.

In one embodiment, the amplifier signal peaks 300 may be analyzed to determine flow rate. A peak in the signal 300 indicates a particle and the width of the given peak indicates air flow rate. A larger width represents slower air flow and/or a larger particle. This analysis may be integrated with the particle detection and sizing algorithms implemented in the control electronics, MCU and/or DSP.

In this embodiment a CMOS thermal flow sensing element 16 may be used to measure the air flow. The CMOS element 16 may be a monolithic silicone device with integrated analog front end and digital interface electronics.

In this embodiment, the CMOS sensor 16 may be populated on the PCB 19 with a mezzanine carrier board to ensure that the sensing surface of the sensor may be co-planar with the surface of the plastics composing the air flow channel 23. This may also be accomplished by the use of flexible PCBs, gradual changes in the height of the plastics across the air path and 3D structured molded interface device (MID) type plastic components. The co-planar flow sensor ensures good air exchange at the surface of the sensor and prevents turbulence or other mixing of the air due to abrupt gaps in the flow geometry.

Variations in flow velocity resulting from fan 13 ageing, contamination of the fan 13, device orientation, variation in voltage, startup time of the fan 13 or blockages in the intake or exhaust ports 23 are corrected for by measuring the flow realized across the flow meter 16. The flow velocity may be measured continuously and thus the mass concentration of the particulates can be computed. Because the flow rate may be not assumed based on a one time calibration, this method may be not prone to drift due to changes in the flow rate.

In one embodiment, the fan 13 has a tachometer output. The flow sensor 16 and tachometer data may be compared to identify whether the loss of flow rate may be the result of contamination of the fan 13 or due to blockages in the air path 23. Contamination of the fan 13 results in lower RPM or greater current consumption. Furthermore, fan 13 deterioration may be gradual while other events are sudden, thus tracking of the time domain of the change in flow rate allows interrogation of the modality of the failure mode. This can then be used to inform the user of the appropriate corrective action. The tachometer may be used by the device as part of its self-diagnostic process. The device records the tachometer reading at full voltage at regular intervals. In this way, it can assess the state of the fan 13.

In this embodiment the sensing region cross sectional area may be invariant between the photodiode 18 and the flow sensor 16, thus the measured flow rate may be equivalent to the flow across the sensing region. In other embodiments, the cross sectional ratio can be larger or smaller. If the realized flow velocity may be too great for the flow sensor 16 to measure accurately, the cross sectional ratio may be modified to reduce the flow velocity to the linear range of the sensor. Thus, regardless of the fan performance, the flow sensor 16 can be used in its preferred operation range.

### 5.5 Air Path

The aerosol sampling path 23 may be constructed from the interface between the enclosure, fan, any electronics or PCBs and any other physical features inside the enclosure. The aerosol sampling path 23 defines the stream of air that may be being measured for entrained particulate. The aerosol sampling path enters through the air intake 23 on the OPC frame 14 to the fan intake 23. The low pressure drop through the system may be due to the short path length of the aerosol sampling channel and allows the use of smaller fans.

To prevent sedimentation or other accumulation of contamination, the air path 23 may be designed to be absent of any small radius turns or other features that create turbulence and zones of low pressure. Thus sedimentation may be kept to a minimum and the ability to clean the device by forcing air through the device may be increased. The user corrective action may be blowing into the device with their mouth, compressed air or gas dusters based on volatile propellant gases to force a large volume of air through the device intake 23 and remove any accumulated contaminates in the air path 23 and the fan 13.

In one embodiment, the air path utilizes a gradual undulation on the intake to block stray ambient light and prevent user access to the laser beamline. This undulation may be gradual and thus not substantially contribute to the impedance of the air path. The undulation may also be of constant cross sectional area or taper, that is, start large and reduce towards the sensing region, to further decrease the flow impedance.

The surfaces of the air path 23 are kept very smooth to reduce the surface energy of the material. The high grade surface finish of the material ensures that particulates have no surfaces available to them where there might be a high affinity between the contaminant and the surface. As a result, when the user cleans the device, the contaminants are readily displaced.

Physical baffles 11 may be incorporated to structure the air flow and control the accumulation of dust and sedimentation. One embodiment may have a large device exhaust cross section and/or short air flow path to further reduce sedimentation from fan exhaust to ambient air outside of device. The baffles may be staggered to block light from a broad range of incident angles.

### 5.6 Laser

A laser 12 may be used as a light source to be scattered by entrained particles in the aerosol sampling path as they move through the device. Other optical components may be used to shape and direct the laser beam over the photodiode 18. Optical gain may be implemented in the form of collecting optics above the photodiode 18. This increases the surface area and improves the signal amplitude.

The laser 12 may be a laser diode with a built-in or separate driving circuit. It may be in a metallic enclosure for electrostatic and thermal protection. The laser 12 may also have a lens to control the focal length of the laser.

The laser 12 contains a monitor diode for automatic power control (APC). APC may be required to maintain stability of the laser over time and over temperature which may be critical to the repeatability of particulate measurements. In one embodiment, the laser 12 may have an external monitor diode. The external monitor diode has the same function as an internal monitor diode as an input into the APC circuit. The use of external monitor diode allows the use of lasers that do not have an integrated monitor diode.

In one embodiment the laser 12 may be a vertical cavity surface emitting laser (VCSEL). The VCSEL laser has a lower beam divergence, resulting in a superior beam shape within the active region 17 at an equivalent spot size relative to other solid state lasers. The uniformity of the beam may be greater in the embodiment utilizing the VCSEL, which reduces the amplitude range for particulates of any singular optical diameter. Thus the sizing resolution of the device may be improved over devices using an edge emitting laser. The VCSEL laser may be more efficient at an equivalent power to that of an edge emitting laser, resulting in lower power consumption and reduced thermal load.

### 5.7 Optical Path

The optical path may be defined as the path the laser beam 12 takes through the device and includes all components that interact with this beam. The major components of the optical path may include the following: lenses, baffles, apertures and beam dumps or other dissipative features. In this embodiment, the optical path may be created with the following components: a single lens with a focal length which may be between 1-50 mm, baffle(s) 11 and aperture(s) 19 as required to prevent stray light from the laser from reflecting directly onto the photodiode 18, and features known as the “beam dump” 22 to dissipate the laser beam after it passes the photodiode. This embodiment uses a horn geometry 22 to dissipate the laser beam energy and reduce reflections. This feature also prevents stray light from reflecting directly into the photodiode 18.

In other embodiments, a plurality of these components may be used to create the optical path. Other embodiments are described in this section. In addition to their description, the other embodiments may include a plurality of other optical features mentioned in this section.

This and other embodiments may use a beam dump with the following features: a chamber with a simple 45° enclosed corner to dissipate the laser beam energy and reduce reflections, surfaces with a reflective material or coating to reduce dispersion of the reflected beam, and/or surfaces painted or colored to reduce reflected energy.

In one embodiment, an optical collection system may be used to increase the amount of scattered light sensed by the photodiode 18. In one embodiment, a parabolic reflector above the primary photodiode 18 may be installed to reflect the scattered light above the photodiode 18 back on to it. In another embodiment, a second photodiode may be installed above the primary photodiode 18 by using a flexible PCB to increase the detection of scattered light.

This and other embodiments may use baffles 11 directly before and after the photodiode to reduce stray light that originates in the laser and may be scattered by various surfaces inside the optical path. The baffles 11 have a thin wall with an aperture 19 slightly greater than the spot size at that position. They do not attenuate the primary beam line, however they block all o-axis stray light. The baffles 11 are sized to accommodate the range of beam orientations inherent in the tolerances of the laser die coaxial precision and the laser mount 25. The baffle 11 walls are fabricated to the minimum effective thickness necessary to prevent transmission through the baffle 11 by the laser 12. The thin walls minimize the amount of light that can reflect off of the inner surfaces of the aperture 19 and into the sensing region 17.

In some embodiments, the optical path may be shrouded through the sensing region. The shroud may be integrated into the baffles 11 to reduce the cross sectional area of interaction between the laser 12 and the air path 23. This reduces the active region 17 and reduces error resulting from the high divergence of a laser 12 with a short focal length. The shrouds are small tubular features facing the photodiode 18 and allow air to flow around them with minimum disruption. The shrouds may have a teardrop cross section to ensure laminar air flow.

In one embodiment, the optical path 23 contains one or more LEDs with a wavelength closely matching that of the laser 12. The LED(s) are mounted on the PCB 19 and reflect off of the plastics of the air path 23 and weakly illuminate the photodiode 18. By measuring the response of the sensing region with the laser 12 disabled and with the LED(s) enabled, the device can perform a self-diagnostic process. By tracking the change in the response of the photodiode 18 to the LED(s) over time, the level of contamination of the air path 23, the photodiode 18 and the flow sensor 16 can be quantified. This allows the device to assess its own state and the validity of its measurements.

### 5.8 Electrical

In this embodiment, a circuit board 208 may be used to mount the various electrical components of the sensor. A photodiode 206 may be mounted, in a fashion known to those skilled in the art, to a PCB at the intersection between the laser beam 210 and the aerosol sampling path 211. The photodiode 206 creates a small current upon sensing light. One embodiment may have a second photodiode located on the other side of the laser beam 210 relative to the first photodiode 206 attached to a flexible PCB constrained by enclosure features.

An amplifier circuit, designed in a fashion known to those skilled in the art, may be mounted near the photodiode 206. A high gain current-to-voltage converter (i.e. a transimpedance amplifier) may be used to amplify the voltage output of the photodiode one or more times into a usable voltage. The circuitry may include an analog low-pass filter with one or more poles. The amplifier may have a plurality of stages which may be AC or DC coupled. The amplifier may be used for analog filtering of the photodiode signal.

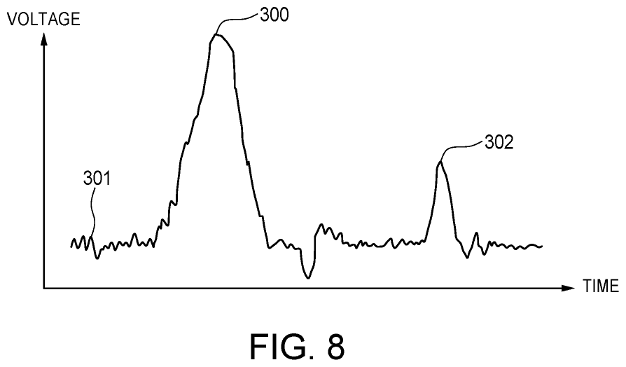

An analog to digital converter may be mounted on the PCB and converts the filtered or unfiltered amplifier voltage to a digital signal. The analog signal in FIG. 8 may be comprised of peaks 300 which represent the light reflected by the airborne particular matter and sensed by the photodiode 206.

The analog signal also has background noise 301 in the form of: quantum noise (shot noise), stray light noise, electromagnetic interference, and other forms of noise or interference. Shielding from the noise 301 may be provided where possible. Active or passive low-pass analog filtering may be used to reduce signal noise 301. The peak detection and sizing algorithm may be calibrated to account for this noise.

The analog signal contains peaks 300, 302 indicating partial or multiple particles crossing the sensing area. These are referred to as boundary and coincidence errors and may be exempted from counting by the peak detection and sizing algorithm. One peak may be associated with one particle in the absence of boundary or coincidence errors. The height of the peak correlates with albedo, the reflecting power of a surface, and the particle size.

The sampling frequency of the ADC depends on the shape of the pulses generated by the sensor. The peak shape may be in influenced by the following components or effects: the photodiode, the amplifier, laser beam width, air flow rate, air flow cross section, humidity, temperature, particle diameter, particle albedo, and other effects.

Control electronics, MCU, or DSP may be used to process the digital signal. The PCB may contain amplifier and control electronics for the fan and laser that are controlled by the MCU or DSP. The MCU or DSP may contain all features required to function, including non-volatile memory for firmware, calibration settings, and device state information. The control electronics, MCU, and/or DSP may be shared with other devices connected to the LSAS.

In this embodiment, the control electronics may decide to enter a low power mode based on user input and/or results from the peak detection and sizing algorithm. One embodiment of a low power sensing mode may involve a reduced sampling time to reduce the duty cycle of the device and extend battery life. In poor air conditions, less logging may be needed to obtain a statistically accurate measurement. To perform this, the control electronics turn the sensor on and sample the air for a standard sampling duration. If the count threshold may be exceeded, the next sampling duration may be reduced. To confirm the statistical significance of the sampling duration, a standard duration sample may be taken for every 1-20 low power samples. If the particle load may be found to have decreased below the threshold, the sampling duration is increased again.

Another low power sensing mode involves using pulse width modulation of the laser and/or fan. In this mode, the laser and/or fan are run at less than 100% duty cycle to reduce their current draw by means of control electronics. Lower sampling rates may be sufficient if the peak amplitude may be sufficiently high above the background noise or if the air may be sufficiently dirty. Again, a standard sample needs to be taken for every 1-20 low power samples to ensure sensor accuracy may be maintained.

In this embodiment one or more flexible circuit boards may be used to locate electronics inside the enclosure. Other embodiments may have one or more of the following: PCBs, photodiodes, amplifier circuits, ADCs, MCUs, and/or DSPs.

In this embodiment a CMOS flow sensor 16 may be integrated directly onto the PCB 19 via a carrier PCB. The microcontroller that samples the optical particle counter sensor may poll the CMOS flow sensor 16 over I2C, SPI or other board level bus to measure the current flow velocity. The microcontroller may record the flow rate continuously to identify change in the flow speed relative to expected value. This may be used as feedback for the fan 13 speed control or may be recorded in the non-volatile memory for future calculation of the mass concentration. In another embodiment, the particle counts may be adjusted as a function of the flow velocity in real time.

In this embodiment, additional sensors can be populated in the region around 24. These sensors may not require light tightness nor laminar air flow. These sensors may include humidity, temperature, CO2, VOC, NOX and other device types.

### 5.9 Power Management

In one embodiment, an accelerometer may be used to detect the orientation and acceleration of the device. The accelerometer may be a 3, 6 or 9 axis accelerometer. The accelerometer may be used to detect displacement of the device and drive power budget logic. When in motion with sufficient velocity the device may disable the fan to reduce power consumption. The device may also vary the duty cycle of sampling as a function of the displacement of the device through space. When stationary, a lower duty cycle may be acceptable, yielding substantial power savings.

In one embodiment, the device has no fan, greatly reducing power consumption. In this embodiment, the accelerometer or flow sensor may be used to confirm that the device can be placed into a sampling state. When there may be insufficient displacement through the active area, the device powers down all the subsystems other than those that service the accelerometer or flow meter. Upon a state chance, these devices wake the rest of the device and prepare it for sampling. Hysteresis ranges are dynamically adjusted to ensure that the waking frequency may be kept in the range that achieves the required battery life.

When using a brushless DC motor based fan, there may be typically no direct possible control of the RPM and thus of the output flow or power consumption of the fan. In one embodiment, a digital to analog converter may be implemented to convert a digital control signal to an analog output. The analog output may be a voltage that may be applied to the fan. The digital signal may be implemented as a pulse width modulation (PWM) and converted using a low pass filter. The voltage can thus be varied from the rated operating voltage of the fan down to the minimum voltage of the brushless motor driver IC. The fan may be run at a selectable voltage allowing the variation of a flow velocity. Reducing the voltage yields power savings and reduces audible noise.

The high power subsystems of the device including the fan, laser and analog front end may be powered down in-between readings to reduce the average power consumption and extend endurance in battery powered configurations. This duty cycle may be the primary determinant of power consumption. However, a static duty cycle fails to address the variable rate of particulate events. The device may implement a dynamic duty cycle control algorithm which increases the duty cycle ratio and frequency upon detection of a large delta in particle counts. This may be done by comparing the current reading to running averages over several time periods. If the rate of change exceeds the threshold, the duty cycle and frequency are altered until the sample to sample rate of change falls below the threshold. This process reduces the sampling resolution during stable periods, greatly reducing power consumption while still capturing high resolution data when there are abrupt changes in the environment.

In an additional embodiment of an apparatus of the present invention comprising an enclosure configured to define an aerosol sampling path and an optical path. A light source, such as a laser, provides a light beam along the optical path. The aerosol sampling path allows an air stream having entrained particles to pass therethrough. The aerosol sampling path intersects with the optical path. The intersection defines a sensing region. The enclosure further having at least one flow rate sensor located near the sensing region and an optical particle detection assembly located in the sensing region. An electronic control assembly provides the control over the embodiment. In operation, the light beam intersects with the air stream in the sensing region, wherein the light beam may be scattered by entrained particles contained in the aerosol sampling path.

In some embodiments, the enclosure may comprise a top cover and may be configured to be wearable by an individual.

In some embodiments, the aerosol sampling path may comprise an air inlet, an aerosol sampling channel and an air exhaust. The cross-section dimensions of the aerosol sampling channel may be smaller than the cross-section dimensions of the air inlet and the air exhaust. Further, the ratio of the cross-section dimension of the air inlet and the aerosol sampling channel may be at least 100:1 and the ratio of the cross-section dimension of the air exhaust and the aerosol sampling channel may be at least 100:1. Additionally, the aerosol sampling path further comprises baffles that may be configured to structure the air stream and control the accumulation of dust and sedimentation. Still further, the aerosol sampling path further may comprise a reflective surface configured to reflect light beam through the sensing region.

In some embodiments, the optical path may comprise an offset chamber offset from the optical path to dissipate the light beam from the light source. It may also comprise baffles configured to reduce stray light from entering the optical particle detection assembly.

In some embodiments, the light source may comprise a laser.

In some embodiments, the optical particle detection assembly may comprise at least one photodiode configured to receive the light from the light source, convert the received light into an electric current, and send the electric current to the electronic control assembly. Further in some embodiments, the apparatus may comprise a bandpass filter 20 disposed on the photodiode for filtering certain frequencies of light and allowing only predetermined frequencies to reach the photodiode.

In some embodiments, the electronic control assembly may comprise a printed circuit board having one or more components configured to receive and process the electric current from the optical particle detection assembly.

In some embodiments, the apparatus may comprise an accelerometer assembly located within the enclosure. The accelerometer assembly may be configured to determine the orientation and acceleration of the apparatus.

In some embodiments, the apparatus may further comprise a fan assembly configured to pull air through the aerosol sampling path creating the air stream. The fan assembly may be located downstream from the sensing region. In some embodiments, the aerosol sampling path may comprise an air inlet, an aerosol sampling channel and an air exhaust. The fan assembly may be located between the sensing region and the air exhaust to provide laminar air flow through the sensing region. In some embodiments, the apparatus may comprise at least one air sensor located downstream from the fan assembly and may be configured to displace air through the aerosol sampling path. The fan assembly may also be configured to direct turbulent air away from the sensing region and may comprise a detachable fan.

In some embodiments, the apparatus may further comprise at least one air sensor located downstream from the sensing region. The apparatus may also further comprise a flow measuring assembly that may be configured to measure the air stream through the aerosol sampling path. The flow measuring assembly may comprise one or more sensing components.

In some embodiments of the system of the present invention comprises an apparatus comprising an enclosure configured to define an aerosol sampling path and an optical path. The aerosol sampling path intersects with the optical path where the intersection defines a sensing region. The enclosure may further include a light source providing a light beam along the optical path, an optical particle detection assembly located in the sensing region, and an electronic control assembly. At least one air flow sensors may be located outside of the apparatus and be configured to communicate with the apparatus. The at least one air flow sensor may be in communication connection with the apparatus through a communication device. The connection may be through a wired or wireless connection.

In some embodiments, the communication device may be configured to connect to an external network for communicating with the external network for obtaining data related to airflow context of the apparatus from the external network.

In some embodiments, the system may further include a power source for providing power to the air flow sensor.

While the invention has been described with a certain degree of particularity, many changes may be made in the details of construction and the arrangement of components without departing from the spirit and scope of this disclosure. The invention may be not limited to the embodiments set forth herein for purposes of exemplification.

What may be claimed:

1. An apparatus for detecting and measuring particles entrained in an air stream, the apparatus comprising:
an enclosure configured to define an aerosol sampling path and an optical path, the aerosol sampling path allowing an air stream having entrained particles to pass therethrough, wherein the aerosol sampling path intersects with the optical path, the intersection defining a sensing region;
at least one flow rate sensor, the at least one flow rate sensor located near the sensing region;
a light source providing a light beam along the optical path;
an optical particle detection assembly located in the sensing region; and
an electronic control assembly,
wherein the light beam intersects with the air stream in the sensing region, wherein the light beam may be scattered by entrained particles contained in the aerosol sampling path.

2. The apparatus of claim 1, further comprising an accelerometer assembly located within the enclosure, the accelerometer assembly configured to determine the orientation and acceleration of the apparatus.

3. The apparatus of claim 1, further comprising a fan assembly configured to pull air through the aerosol sampling path creating the air stream, the fan assembly being located downstream from the sensing region.

4. The apparatus of claim 1, wherein the aerosol sampling path comprises:
an air inlet;
an aerosol sampling channel; and
an air exhaust,
wherein the cross-section dimensions of the aerosol sampling channel may be smaller than the cross-section dimensions of the air inlet and the air exhaust.

5. The apparatus of claim 4, wherein the ratio of the cross-section dimension of the air inlet and the aerosol sampling channel may be at least 100:1.

6. The apparatus of claim 4, wherein the ratio of the cross-section dimension of the air exhaust and the aerosol sampling channel at least 100:1.

7. The apparatus of claim 3, wherein the aerosol sampling path comprises:
an air inlet;
an aerosol sampling channel; and
an air exhaust,
wherein the fan assembly may be located between the sensing region and the air exhaust to provide laminar air flow through the sensing region.

8. The apparatus of claim 1, wherein the aerosol sampling path further comprises baffles configured to structure the air stream and control the accumulation of dust and sedimentation.

9. The apparatus of claim 1, wherein the aerosol sampling path further comprises a reflective surface configured to reflect light beam through the sensing region.

10. The apparatus of claim 1, further comprising at least one air sensor located downstream from the sensing region.

11. The apparatus of claim 3, further comprising at least one air sensor located downstream from the fan assembly.

12. The apparatus of claim 3, wherein the fan assembly may be configured to displace air through the aerosol sampling path.

13. The apparatus of claim 3, wherein the fan assembly may be configured to direct turbulent air away from the sensing region.

14. The apparatus of claim 3, wherein the fan assembly comprises a detachable fan.

15. The apparatus of claim 1, wherein the optical path further comprising an offset chamber offset from the optical path to dissipate the light beam from light source.

16. The apparatus of claim 1, wherein the optical path further comprises baffles configured to reduce stray light from entering the optical particle detection assembly.

17. The apparatus of claim 1, wherein the light source comprises a laser.

18. The apparatus of claim 1, wherein the optical particle detection assembly comprises at least one photodiode, the at least one photodiode configured to receive the light from the light source, convert the received light into an electric current, and send the electric current to the electronic control assembly.

19. The apparatus of claim 1, wherein the electronic control assembly comprises a printed circuit board, the printed circuit board comprising one or more components configured to receive and process the electric current from the optical particle detection assembly.

20. The apparatus of claim 1, further comprising a flow measuring assembly, the flow measuring assembly configured to measure the air stream through the aerosol sampling path.

21. The apparatus of claim 20, wherein the flow measuring assembly comprises one or more sensing components.

22. The apparatus of claim 1, wherein the enclosure further comprises a top cover.

23. The apparatus of claim 1, wherein the apparatus may be configured to be wearable by an individual.

24. The apparatus of claim 18, further comprising a bandpass filter 20 disposed on the at least one photodiode for filtering certain frequencies of light and allowing only predetermined frequencies to reach the at least one photodiode.

25. A system for detecting and measuring particles entrained in an air stream, the system comprising:
an apparatus comprising:
an enclosure configured to define an aerosol sampling path and an optical path, wherein the aerosol sampling path intersects with the optical path, the intersection defining a sensing region,
a light source providing a light beam along the optical path,
an optical particle detection assembly located in the sensing region, and
an electronic control assembly;
at least one air flow sensors located outside of the apparatus, the at least one air flow sensor configured to communicate with the apparatus; and
a connection between apparatus and the at least one air flow sensor for allowing the apparatus and at least one air flow sensor to communicate with each other.

26. The system of claim 25, further comprising a power source for providing power to the air flow sensor.

27. The system of claim 25, wherein the connection comprises a wire connection or a wireless connection.

28. A system for detecting and measuring particles entrained in an air stream, the system comprising:
an apparatus comprising:
an enclosure configured to define an aerosol sampling path and an optical path, wherein the aerosol sampling path intersects with the optical path, the intersection defining a sensing region,
a light source providing a light beam along the optical path,
an optical particle detection assembly located in the sensing region, and
an electronic control assembly; and
a communication device configured to connect to an external network for communicating with the external network for obtaining data from the external network, the data being related to airflow context of the apparatus.
